(19) United States
(12) Patent Application Publication
(10) Pub. No.: US 2006/0098288 A1
(43) Pub. Date: May 11, 2006

(54) Diffuser plate of backlight module

(75) Inventors: Bor-Jyh Pan, Chu-Nan (TW); Shoichi Ueda, Tokyo (JP)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/134,254

(22) Filed: May 23, 2005

(30) Foreign Application Priority Data
Nov. 10, 2004 (TW) 93134200

(51) Int. Cl. G02B 13/20

(52) U.S. Cl. 359/599

(57) ABSTRACT

A diffuser plate utilized in a backlight module, wherein the diffuser plate comprises a glass plate adopted as the base, and a diffusive material utilized in a diffusion-treatment. The preferred embodiments of the present invention include coating diffusive particles on the surface of the glass substrate, embedding diffusive particles into the glass substrate, and gluing a diffusive sheet onto the surface of the glass substrate or the diffusive sheet's covering the surface of the glass substrate, all of which can form a diffuser plate with a superior distortion-resistance, heat-resistance, and humidity-resistance.

### FIELD OF THE INVENTION

The present invention relates to a backlight module, particularly to a diffuser plate utilized in a backlight module, wherein the diffuser plate has a superior distortion-resistance, heat-resistance and humidity-resistance.

### BACKGROUND OF THE INVENTION

Generally speaking, a backlight module refers to an assembly of parts that provides a backlight source for the product. The typical application thereof is the light source of a liquid crystal display. The light-emitting elements currently used by a backlight module include electron luminescence (EL), cold cathode fluorescent lamp (CCFL), and light-emitting diode (LED). According to disposing manners of the light-emitting elements, the backlight module is divided into the direct type and the edge-side type. Recently, owing to the prosperous development of the portable electronic products and communication-related industry, the market of the large-size LCD grows quickly. Therefore, the demand for the direct type backlight module also increases obviously.

FIG. 1 is a sectional view of a conventional direct type backlight module including light-emitting elements 10, a rear housing 11, a reflector 12, a diffuser plate 13, and an optical film 14. The light-emitting elements 10, which are CCFLs arranged in parallel with each other or planar lamp plates distributed over the whole surface, providing the light source. The rear housing 11, which is made of an aluminum plate and installed in the back side of the light-emitting elements 10, providing a better heat-dissipating property and reflecting the light from the back to the front light-exit side for increasing the light-utilization efficiency. The reflector 12, which interposes between the light-emitting element 10 and the rear housing 11 and covers one surface of the rear housing 11, utilized to reflect the light from the backside to the front light-exit side. The diffuser plate 13, which is installed in the light-exit side in the front of the light-emitting element 10, enabling the light distribution uniform. The optical film 14 is composed of a diffusive sheet, a prismatic plate, and a polarizer, wherein the diffusive sheet has a diffusively fogging ability, and the prismatic plate has a light-condensing function, and the polarizer has a polarizing and light-intensifying function. The optical film is installed between the liquid crystal panel 15 and the diffuser plate 13.

Generally speaking, the diffuser plate 13 is made of a plastic material, such as an acrylic, polycarbonate (PC) or methacrylstyrene (MS). Those plastic materials are easily influenced by the temperature and humidity for a long time and will be distorted toward the light-emitting element 10 or the liquid crystal panel 15, degrading the display quality of LCD. In other words, the traditional diffuser plate 13 is made of the plastic material and easily distorted, which results in uneven distance between the diffuser plate 13 and the light-emitting element 10, and induces an inferior light-uniformity or a mura. Moreover, the extent of the distortion is difficult to control, it is required reserving a larger spacing between the liquid crystal panel 15 and the diffuser plate 13 for the distortion. Thus, the thickness of the backlight module is difficult to reduce.

### SUMMARY OF THE INVENTION

The object of the present invention is to provide a diffuser plate with a superior heat-resistance, humidity-resistance, and distortion-resistance.

To achieve the aforementioned object, a glass is adopted as the material of the substrate in the present invention. In comparison with a plastic material, a glass is difficult to be distorted by the gravitational force or heat and has a better humidity-resistance. Via the diffuser plate made of a glass, the spacing between the optical film and the light source can be secured, so as to maintain the stable light-uniformity.

The diffuser plate of the present invention comprises a glass substrate and a diffusive material, wherein the preferred embodiments include coating diffusive particles onto the surface of the glass substrate, embedding diffusive particles into the glass substrate, and gluing a diffusive sheet onto the surface of the glass substrate or the diffusive sheet's covering the surface of the glass substrate, all of which form a diffuser plate with a superior distortion-resistance, heat-resistance, and humidity-resistance.

The preferred embodiments and detailed technical contents are to be described below in cooperation with the drawings.

### BRIEF DESCRIPTION OF THE DRAWINGS

FIG. 1 is a sectional view of a conventional direct type backlight module.

FIG. 2 is a sectional view of the direct type backlight module utilizing the diffuser plate of the present invention.

FIG. 3 is a sectional view of the diffuser plate according to a first preferred embodiment of the present invention.

FIG. 4 is a sectional view of the diffuser plate according to a second preferred embodiment of the present invention.

FIG. 5 is a sectional view of the diffuser plate according to a third preferred embodiment of the present invention.

FIG. 6 is the sectional view of the diffuser plate according to a fourth preferred embodiment of the present invention.

FIG. 7 discloses a sectional view of the embodiment that a transparent plastic film is glued onto the surface of the diffuser plate according to the present invention.

FIG. 8 discloses a first embodiment that the diffusion-treatment is performed on the surface of the diffuser plate according to the present invention.

FIG. 9 discloses a second embodiment that the diffusion-treatment is performed on the surface of the diffuser plate according to the present invention.

### DETAILED DESCRIPTION OF THE PREFERRED EMBODIMENTS

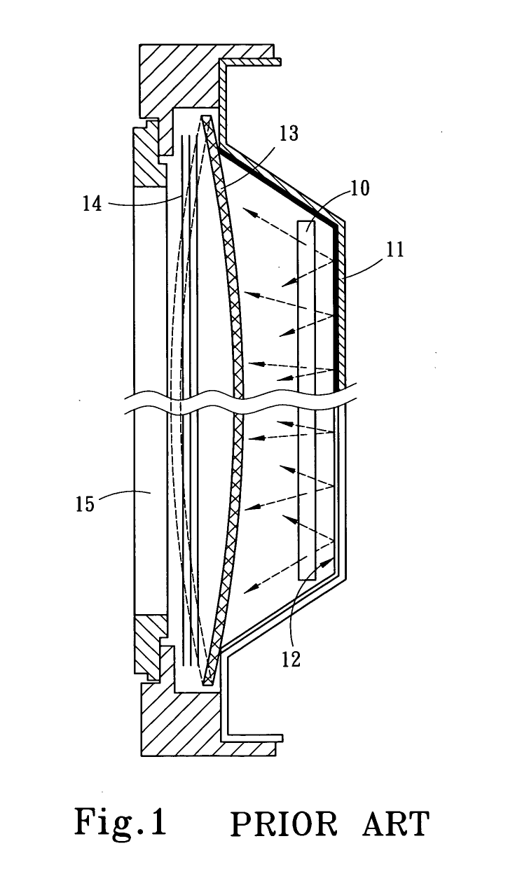

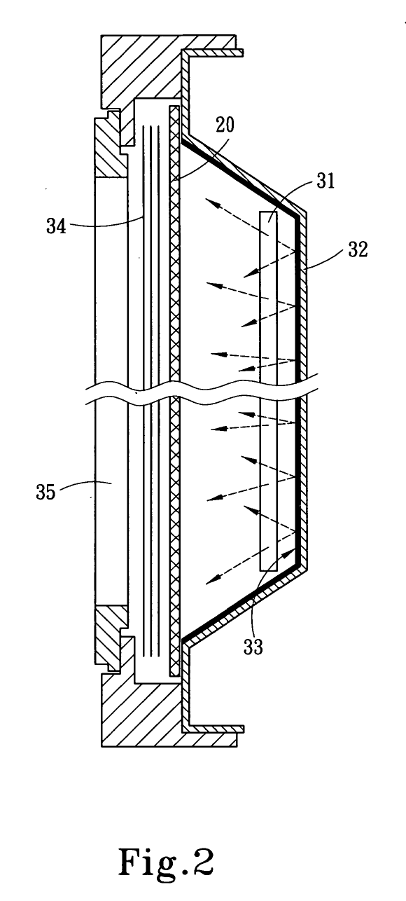

Please refer to FIG. 2; the backlight module is similar to the elements of the conventional structure shown in FIG. 1. The backlight module comprises a light-emitting element 31 (such as CCFL or planar lamp plate), a rear housing (made of an aluminum plate), a reflector 33, a diffuser plate 20, an optical film 34, and a liquid crystal panel 35.

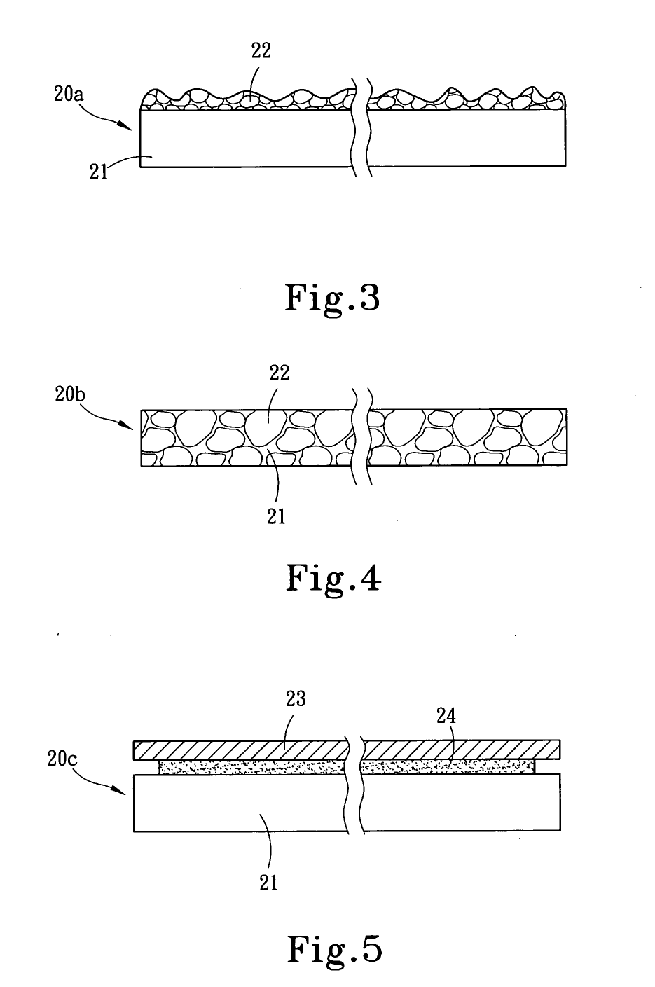

The diffuser plate 20 of the present invention includes the following preferred embodiments. As shown in FIG. 3, the diffuser plate 20a adopts a glass substrate 21 as the base, and coating diffusive particles 22 onto the surface of the glass substrate 21.

FIG. 4 shows a diffuser plate 20b of another embodiment, which is formed by embedding the diffusive particles 22 evenly into the glass substrate 21.

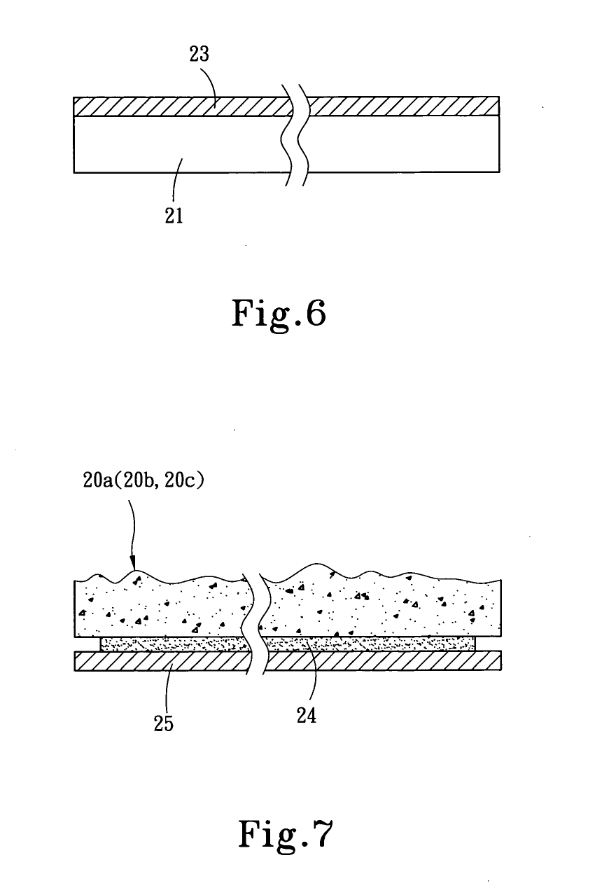

FIG. 5 shows a diffuser plate 20c of another embodiment. A diffusive sheet 23 is gluing onto the surface of the glass substrate 21 with a glue agent 24 to form a complex diffuser plate 20c. The diffusive sheet 23 can be glued onto only one surface or both surfaces of the glass substrate 21 according to the need. The diffusive sheet 23 can be selected from the thin diffusive sheets made of an acrylic, polycarbonate (PC), or methacrylstyrene (MS). The glass substrate 21 is difficult to be distorted by the gravitational force or heat, and has a superior humidity-resistance, so the complex diffuser plate 20c has a superior distortion-resistance, heat-resistance, and humidity-resistance. Obviously, the diffusive sheet 23 can directly cover the surface of the glass substrate 21 without utilizing the glue agent 24, as shown in FIG. 6.

As shown in FIG. 7, the aforementioned diffuser plates 20a, 20b, or 20c, which adopt the glass substrate 21 as a base, and gluing a transparent plastic film 25 (such as a PET film) onto another surface (without diffusion treatment) with the glue agent 24. Thereby, the glass fragments will not spatter out when the glass substrate 21 is broken, so as to enhance the safety. Further, the plastic film 25 can be selected from those specially treated or having special functions, such as an Indium-Tin-Oxide (ITO) film or an anti-infrared-light plastic film for achieving a special function or an anti-heat-radiation ability. Besides, the strength of the glass substrate 21 can be also enhanced via a strengthening treatment, such as a heat treatment.

According to the demand for the diffusion, the diffusion treatment can be undertaken on a single or both surfaces of the glass substrate 21. The diffusive particle 22 can be selected from an inorganic or a high-polymer diffusive particle. The TFT diffuser plate 20 adopts a ball-like diffusive particle to achieve a better optical effect.

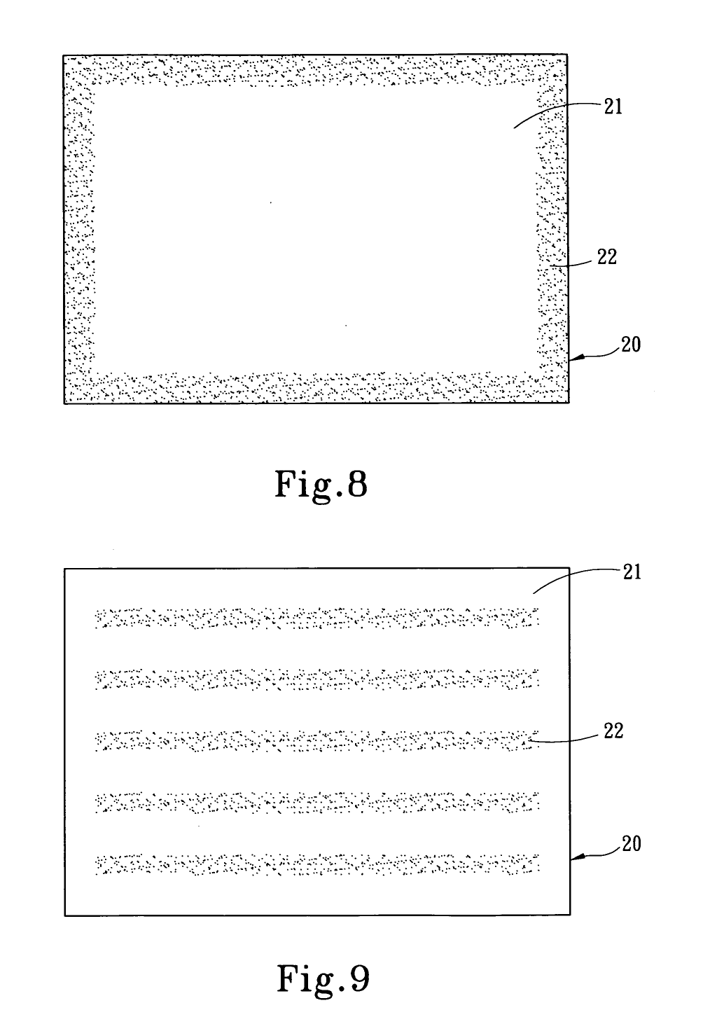

Referring to the optical characteristics of the light source (e.g. planar lamp plate or CCFL), such as its position, brightness, the diffusive particles 22 can be distributed according to a specified pattern, or over some specified regions. As shown in FIG. 8, the periphery of the glass substrate 21 is diffusion-treated with the diffusive particles 22. As shown in FIG. 9, some regions on the glass substrate 21 are diffusion-treated with diffusive particles 22, wherein those regions are above the light-emitting elements 31 for reducing the shadow problem.

Although the present invention has been described in detail, it should be understood that various modifications, alterations, or substitutions can be made without departing from the spirit and scope of the invention as defined by the appended claims.

What is claimed is:

1. A diffuser plate of a backlight module, utilized in a backlight module comprising at least one light-emitting element and a liquid crystal display panel, the diffuser plate making the light emitted from said light-emitting element uniform and be taken as the light source of said liquid crystal display panel, wherein said diffuser plate comprises:
a glass substrate taking as the base; and
a diffusive material utilized in a diffusion treatment.

2. The diffuser plate of a backlight module according to claim 1, wherein said diffusive material is a diffusive particle.

3. The diffuser plate of a backlight module according to claim 2, wherein said diffusive particles are coated onto the surface of said glass substrate.

4. The diffuser plate of a backlight module according to claim 3, wherein a diffusion treatment is undertaken on a single surface of said glass substrate with said diffusive particles.

5. The diffuser plate of a backlight module according to claim 3, wherein said diffusion treatment is undertaken on both surfaces of said glass substrate with said diffusive particles.

6. The diffuser plate of a backlight module according to claim 2, wherein said diffusive particles are evenly embedded into said glass substrate.

7. The diffuser plate of a backlight module according to claim 2, wherein said diffusive particles are an inorganic type or a high-polymer type.

8. The diffuser plate of a backlight module according to claim 1, wherein said diffusive material is a diffusive sheet, and said diffusion treatment is realized via that said diffusive sheet directly covers the surface of said glass substrate, or said diffusive sheet is glued onto the surface of said glass substrate with a glue agent.

9. The diffuser plate of a backlight module according to claim 8, wherein a single-side said diffusion treatment is undertaken on a single surface of said glass substrate with said diffusive sheet.

10. The diffuser plate of a backlight module according to claim 8, wherein a dual-side said diffusion treatment is undertaken on both surfaces of said glass substrate with said diffusive sheet.

11. The diffuser plate of a backlight module according to claim 8, wherein said diffusive sheet is a thin diffusive film made of an acryl, a polycarbonate, or a methacrylstyrene.

12. The diffuser plate of a backlight module according to claim 1, further comprising a transparent plastic film glued onto the non-diffusion-treated surface of said glass substrate with said glue agent.

13. The diffuser plate of a backlight module according to claim 12, wherein said transparent plastic film is a PET film or an ITO film.

14. The diffuser plate of a backlight module according to claim 12, wherein said transparent plastic film is an anti-infrared-light plastic film.

15. The diffuser plate of a backlight module according to claim 1, wherein said glass substrate is treated with a strengthening process.
